(19) United States
(12) Patent Application Publication
(10) Pub. No.: US 2007/0271464 A1
(43) Pub. Date: Nov. 22, 2007

(54) Method of sending and validating documents

(76) Inventor: Francisco Jose Rico Novella, Barcelona (ES)

Correspondence Address: DEFILLO & ASSOCIATES, INC., P.O. Box 14104, Clearwater, FL, 33766, US

(21) Appl. No.: 10/501,211

(22) PCT Filed: Jan. 10, 2003
(86) PCT No.: PCT/ES03/00008

§ 371 Date: Jul. 14, 2004

(30) Foreign Application Priority Data
Jan. 15, 2002 (ES) P200200070

(51) Int. Cl. H04L 9/00

(52) U.S. Cl. 713/181

(57) ABSTRACT

The invention relates to a method of sending and validating documents using authentication codes and portable verifier elements which can process and store information and which offer a high level of protection against unauthorised readers and writers. The inventinve method is characterised in that the aforementioned authentication code is generated specifically for a particular portable verifier and is indicated directly or indirectly by the person requesting the document. In this way, no data record of any type is required in the portable verifier element up to the point at which the document is validated. It is essential, however, that the portable verifier be actively involved in the validation, said portable verifier containing a stored list of validated documents such that it is possible to determine, at least, whether or not is the first validation.

### CROSS REFERENCE TO RELATED APPLICATION

This application is a national stage of PCT/ES03/00008 filed Jan. 10, 2003 and based upon SPAIN ES2002000000070 filed Jan. 15, 2002 under the International Convention.

### FIELD OF THE INVENTION

This invention is in reference to the above-described method, and makes it impossible to make a fraudulent copy of a document. As is explained below, the method to be outlined in greater detail herein offers several advantages.

Although this report specifically deals with those cases where the documents to be obtained are tickets, the method introduced by said invention can also be applied to other, more general, types of document, as will be explained further on.

### BACKGROUND OF THE INVENTION

Today it is possible to order or book many different types of ticket, such as plane tickets, train tickets, admission tickets to shows, etc. through telesales systems. Said tickets can be paid for in several different ways, by credit card or by charging the cost to a bank account, or an account in a similar institution.

Nevertheless, to collect tickets purchased in this way, these must be sent to the purchaser by post or using a messenger service, meaning increased issuing costs and an inconvenience for the user, in the event these have to travel to pick them up.

Until now, tickets have been delivered in this way principally because the authenticity of this type of document is based on a certain characteristic of the support used (the paper) or the printing method to make these more difficult to falsify. This means that the user cannot obtain a printed copy of the document in question.

As an alternative to this method, the abovementioned technique proposes several different systems for remotely sending tickets and a brief summary of these is given below.

The first system is the one described, to a greater or lesser degree in documents n° WO01/61577A2, WO00/74300A1, WO00/45348, WO200161577, WO200744300, WO20045348 and U.S. Pat. No. 5,598,477, and is principally based on coding the data considered relevant and then encrypting this, using asymmetric or symmetric key techniques. The result of this encoding is then printed as a barcode or similar so that it can be automatically checked when being validated. This system makes it impossible for anyone who does not know the encryption key to generate tickets (in the event asymmetric key cryptography is used, this would refer to the secret key of the algorithm). However, one disadvantage of this method is that it is possible to obtain copies of a ticket that has already been sent and, as a result, it is necessary to use other additional security measures, such as the on-line control of validated tickets, the inclusion of verifiable personal data (National ID-number) passport, or other) in the encrypted code (in the case of (those tickets that include a fixed date or place of use), etc. The system is especially inefficient in the case of tickets that can be used on a wide range of dates, such as hotel vouchers, public transportation tickets, etc. and in places where there are a lot of people trying to gain admission, as the time needed to check—the identity of the holder would create serious inconvenience. For all of the above reasons, this system is not widely used in practice.

Another possible system is the one described, to a greater or lesser degree, in documents EP0969426 A1, f P0829828 A, EP969426, JP116397, EP9318 and others, and Is based on recording the ticket information on a device such as a smart card. As the recording device (card) allows the use of cryptographic techniques for firm identification and makes it extremely difficult to violate the information stored therein, it is practically impossible to duplicate the ticket, thus guaranteeing there is no more than one. Therefore, it is not necessary to carry out on-line control to validate the ticket nor it is necessary to identify the holder when the ticket is to be used. Nevertheless, one disadvantage of this system is that the user is required to have a smart card recording peripheral in their house, making the system extremely costly to use, which is why it is rarely employed in practice.

An alternative to these systems for remotely sending tickets is proposed by the new method introduced by this invention, and this solves all the problems related with other known systems. The invention proposes a new method for obtaining documents (for example, tickets) generally at the user's home and their later automatic validation. Thanks to the new method introduced by this invention it impossible to make a fraudulent duplicate of any ticket (thus guaranteeing there is no more than one) and makes it unnecessary for the user to have a smart card reader/recorder, thus making the system more flexible and less costly.

The method introduced by this invention uses cryptographic techniques along with portable verifier devices which can process and store information and which offer a high level of protection against unauthorized readers and writers and make it very difficult to make fraudulent copies.

The most appropriate portable verifier devices are smart cards.

Although, theoretically speaking, it is more appropriate to use public key cryptography to obtain authentication codes (as this means it is not necessary to store secret keys during the validation stage), the codes will be considerably larger than necessary in size, if secret key (symmetric) cryptography is used. If the document is not to be printed but presented in another format (magnetic, optical, electronic support, etc.) this has no particular relevance. However, in the event tine document is to be printed, the fact the authentication code is to be read automatically makes it necessary to use dot codes, which means more expensive apparatus will be required to read than. For this reason, and to facilitate printed support, the use of symmetric key cryptography is preferable contrast, it is necessary to use secure key storage devices, generally security microprocessors, in the verifiers.

### SUMMARY OF THE INVENTION

The invention is a secure system to remotely send documents (usually tickets and generally through Internet from a browser and validate these using automatic readers (generally barcode readers), which can read/write in the portable verifier devices (generally smart cards). To improve reading speed, sturdiness and versatility it is recommended that no direct contact be necessary when using a portable verifier device.

The elements involved in the entire process of the invention are as follows:

The portable verifier device sender: this is in charge of providing the portable verifier devices necessary to validate the documents.

The portable verifier device operator: this encrypts the document to be decrypted by the portable verifier device.

In order to carry out this function, the corresponding keys must he loaded into the portable verifier device. A portable verifier device can support several portable verifier device operators. A portable verifier device operator may coincide with a portable verifier device sender.

A document portal: this is in charge of providing the interface necessary to select and, where applicable, purchase a document. Once a document has been selected, the portal sends the appropriate data to a reader operator so that it can be encrypted using the key of the group of readers/verifiers/recorders in charge of validating the document.

A reader operator: this is in charge of encrypting the document to be decrypted by the above mentioned group of readers/verifiers/recorders. A reader operator may coincide with a portal.

A reader/verifier/recorder: this reads the document's authentication code, transmits this to the portable verifier device, receives the response, decrypts the reader operator using the corresponding code and validates or rejects the document.

A portable verifier device: this receives the document's authentication code (transmitted by the reader/verifier/recorder), and, provided this has not been cancelled beforehand, decrypts the portable verifier device operators using the corresponding code, includes this in the list of cancellations and sends the results of the decryption to the reader/verifier/recorder.

The method for sending and validating, documents introduced by this invention is carried out using authentication codes and portable verifier elements which can process and store information and which offer a high level of protection against unauthorized readers and writers.

The inventive method is characterised in that the aforementioned authentication code is generated specifically for a particular portable verifier and is indicated directly or indirectly by the person requesting the document. In this way, no data record of any type is required in the portable verifier clement iii) to the point at which the document is validated. It is essential, however, that the portable verifier be actively involved in the validation, said portable verifier containing a stored list of validated documents such that it is possible to determine, at least whether or not this is the first validation.

### DESCRIPTION OF THE INVENTION

This method for sending and validating documents is comprised of the following phases:

The document is generated from a document portal and the data considered relevant is coded using the key that corresponds to the group of readers/verifiers/recorders involved in the validation of the document, so that the, first cryptographic operation can be carried out. Linked to the first one, there is another second cryptographic operation which includes the key corresponding to the portable verifier device associated with the document, and, as a result of these cryptographic operations, an authentication code is created for the 4docnnnent and is incorporated therein; and

The document is checked by reading its authentication code, and the appropriate third cryptographic operations are carried out to verify those already employed to generate the document. It is essential, however, that the portable verifier device associated for the validation of the document be actively involved, and a portable verifier should contain a list of validated documents such that it is possible to determine, at least, whether or not this is the first validation.

In accordance with the design of the invention, the portable verifier devices can be individualized by storing one or more portable verifier device keys, which must be a symmetric or secret key encryption algorithm. In addition, the first and second cryptographic operations are made up of two encryptions using a symmetric cryptographic algorithm, one with the key of the group of readers/verifiers/recorders involved in the validation of the document and the other with the key that corresponds to the portable verifier device associated with the document. The third cryptographic operations consist of decrypting, by the portable verifier device using its corresponding, key, of the document's authentication code and the subsequent decryption, carried out by the aforementioned reader/verifier/recorder and its corresponding code. Both decryptions will be effected through symmetric cryptographic algorithms.

Ideally, the portable verifier devices should be individualized by storing one or more portable verifier device keys, which must be the secret keys of an asymmetric or public key cryptographic algorithm. The above-described first and second cryptographic operations are based on public key cryptography, which is composed of a digital signature with a secret key, and the readers/verifiers/recorders involved in the validation of the document will know its corresponding public key, and an encryption with the corresponding public key of the portable verifier device associated with the document. The third cryptographic operations will be based on public key cryptography composed of a decryption using the secret key corresponding to the portable verifier device associated with the document and the verification of the signature, with the corresponding public key stored in the readers/verifiers/recorders.

Alternatively, the portable verifier devices can be individualized by storing one or more portable verifier device keys, which must be the secret keys of an asymmetric or public key encryption algorithm. The above-described first and second cryptographic operations are based on public key cryptography which is composed of an encryption using the public key of the readers verifiers/recorders involved in the validation of the document and an encryption using the public key corresponding; to the portable verifier device associated with the document. The abovementioned third cryptographic operations will be based on IMP key cryptography composed of a decryption using the secret key corresponding to the portable verifier device associated with the document and a decryption using the secret key of said readers/verifiers/recorders.

This invention also offers the possibility of individualizing the portable verifier devices by storing one or more portable verifier device keys, which must be the public keys of an asymmetric or public key cryptographic algorithm. The first and second cryptographic operations are based on public key cryptography which is composed of a digital signature using a secret key corresponding to the public key stored in the readers/verifiers/recorders involved in the validation of the document, and another digital signature using the secret key corresponding to the appropriate individualization key stored in the portable verifier device associated with the document. The abovementioned third cryptographic operations will be based on public key cryptography composed of the verification of the signature by the portable verifier device associated with the document with the appropriate individualization key and a second verification of the signature using the public key of the readers/verifiers/recorders.

Another alternative way to individualize the portable verifier devices is by storing one or more portable verifier device keys, which must be the public keys of an asymmetric or public key cryptographic algorithm, and the first and second cryptographic operations are based on public key cryptography which is composed of an encryption using the public key corresponding to the secret key stored in the readers/verifiers/recorders involved in the validation of the document and a digital signature using the secret key corresponding to the appropriate individualization key stored in the portable verifier device associated with the document The third cryptographic operations will be based on public key cryptography composed of the verification of the signature by the portable verifier device associated with the document using the appropriate individualization key and a decryption using, the secret key corresponding to the readers/verifiers/recorders.

In addition, before the validating the document, the method introduced by the invention also checks that this has not already been included in the list of validated documents.

What's more, the reader/verifier/recorder will be informed if the document to be validated has already been included in the list of validated documents, so that it can proceed as appropriate.

The document to be validated will then be included in the list of validated documents, provided it does not already appear therein, and the corresponding cryptographic operation will be carried out when reversing and/or checking the cryptographic operation corresponding to the portable verifier device, and the result will be sent to the reader verifier/recorder so that it can proceed as appropriate.

One advantage is that the cryptographic authentication established between the portable verifier device and the reader/verifier/recorder is both mutual and firm.

One fact of particular importance is that a cooperative and random session key is established between the portable verifier device and the reader/verifier/recorder and this is used to encrypt all pertinent messages between the two.

Ideally senders should individualize the portable verifier devices using one or more keys obtained from the encryption of the serial number using one or more master keys chosen by the portable verifier device operators, so that the master key of each operator and the portable verifier device corresponds with the identifier, which should be legible by the user.

In accordance with this invention, the abovementioned reader/verifier/recorder has been adapted to send information, accepting or rejecting the document and stating the reason why.

Another advantage of this method is that the reader/verifier/recorder keys are common to the group of readers.

The keys stored in the readers/verifiers/recorders are obtained by encrypting the identifiers, or parts of these, using the master keys chosen by the operators.

In the event the document has an expiry date, this will be included in the authentication code, so that they can be eliminated from the list of validated documents stored in the portable verifier once this date has passed.

On the other hand, said portable verifier devices receive the (late expired documents are to be deleted from the list of validated documents through a digital certificate wilt by a competent body.

The document and/or authentication code can be selected and obtained through Internet and the document's authentication code can be sent to the user's mobile phone or electronic agenda, or indeed any similar device belonging to the user.

Another characteristic of the invention is that it is possible to print the authentication code through one or more barcodes. In the case of several barcodes, these will include the correct reading order. It will also be possible to print the authentication code alphanumerically or through a dot code. The authentication code can be printed alphanumerically so that this can by keyed in manually in the event the automatic reading code deteriorates.

The method described guarantees the documents are unique and authentic. The encryptions of the authentication codes is carried out using two secret keys, which ensures authentic documents cannot be generated externally. The document can be made unique by associating one of the encryptions with the portable verifier device. In the event the document is duplicated by a system, no result will be obtained, as once the portable verifier device has validated the document it will not revalidate this. Thus, to be able to rise a copy it would also be necessary to duplicate the portable verifier device, which is impossible due to its characteristics.

On the other hand, it is also possible to cancel documents without needing to send black lists to the reader/verifier/recorder. In order to cancel a document, the holder has to take the document in question and the portable verifier device to an authorized office. The document will then be entered as cancelled in the portable verifier device in such a way that, should the purchaser have kept a copy of the document, he will not be able to use this, as the portable verifier device will no longer validate it.

If we wish to avoid overloading the storage capacity of the portable verifier device, the following should be borne in mind when including lists of cancelled documents. Documents that expire should include an expiry date in the authentication code, so that once they are out of date, they can be eliminated from the list and no longer take up space. The portable verifier devices should incorporate an administrator for residual cancellations to detect expired documents and clear the lists after the date obtained from a certificate provided by the realer/verifier/recorder. The date is obtained from a central server that certifies this through a public key system. This certificate, which may be sent just once a day, is sent to the portable verifier device which, after verifying its authenticity, eliminates the documents that have been cancelled according to the certified date from the list. Needless to say an expired document will never be accepted as valid.

This is a universal system that can be used by many different services (admissions tickets, transport tickets, season tickets, vouchers, cheques, lottery tickets, etc.), several internal portals, and several portable verifier device operators. Although this system is especially useful in the case of printed format, it can be also be used with other different types of format, such as diskettes, storage on mobile telephones, portable electronic agendas or similar, Bluetooth cards, optical discs, CDs, etc.

The alternative used is the case of mobile telephones and electronic agendas is particularly interesting, as it is possible to send the document's authentication code to the purchaser's mobile phone through an SMS text message or using, WAP technology, and when the document is to be used, the purchaser can download this in the reader/verifier/recorder using an infrared link, radio link (for example, Bluetooth or SMS, etc.) or another similar system.

In this case, as indicated above, there is no restriction on the length of the barcode, which means that public key cryptography can be used without any problems.

Underneath is a description of how public key cryptography call be used to generate the authentication code.

First of all, it is necessary to select the relevant information, code it and digitally sign it using the secret key of the appropriate reader operator (the reader/verifier/recorder responsible for checking the corresponding public key is stored in the document).

Then, the result of the previous operation is encrypted using the public key of the portable verifier device associated with the document (the portable verifier device charged with validating the document has the corresponding key secret stored inside).

The verification process is explained below:

The authentication code is read and transmitted to the portable verifier device, which decrypts this using its secret key and introduces it into the list of validated documents in the event this document was already included on the list, the reader/verifier/recorder will be notified).

Said reader/verifier/recorder receives this decryption and checks the validity of the signature using the public key of the reader operator that generated the. authentication code. If the signature is correct, it accepts the document and, if not, the document will be rejected.

There are four possible combinations when public; key cryptography for this purpose and these are the encryption (signature) as explained above, signature (signature), encryption (encryption) and signature (signature). It should be noted that, although all four options are possible, ideally the first should be used, as it minimizes the risks of attacks on the system. Specifically, it makes the secret key of the reader operator unnecessary and prevents the content of the security code from being read.

Another advantage offered by the method presented by this invention is that it is possible to generate documents of a determined type or service for the portable verifier devices of different operators. Thanks to this functionality, it is possible for several different portals associated with different operators of portable verifier devices to generate documents for the same service.

In addition, this invention ensures that the different services and portable verifier device operators cannot affect the operation and security of other services and operators for which they have not been given authorization. What's more, the user can remain anonymous and the system can be used by anybody with an appropriately programmed smart card (portable verifier device), but does not require personal identification of the user (only the card has to be identified and this can be impersonal and transferable).

One especially important aspect of the method described is that it can be easily implanted with the current ticket issuing systems.

The method for sending and validating documents of this invention can be used for several different types of document in many different services and applications. Some examples of the different types of document are admission tickets into cinemas, theatres, shows, etc. where an extra service, for example parking, can be contracted. “pickets for trains, buses, ships and any form of transport in general where there is a specific date to travel and a ticket inspector (not a boarding card), plane tickets, where a boarding card is necessary, hotel vouchers and vouchers for admission to festivals, etc. when neither the date nor the place have been specified beforehand, season tickets for city transport, for example by subway, bus, local or suburban train when neither the date nor the period have been specified beforehand, vouchers for sales promotions, cheques, lottery tickets, etc.

Underneath is an explanation of how the method introduced by this invention should preferably be carried out.

We are going to look at one specific case in which there is only one sending card operator, which also functions as a reader operator. In addition, the system is used to sell tickets over the Internet to be later printed in the client's home using a standard 300 dpi printer.

MIFARE ProX cards are used as portable verifier devices and these have been personalized using a key obtained by encrypting the serial number of each card using DES Triple with a master key. Thus, it is not necessary to save the correspondence between the serial number and the card key in a database. The entire protocol to be maintained with the reader/verifier/recorder is programmed in the cards and these arc also given a list of cancelled tickets with the method for eliminating the expired tickets from the list by inserting a dale certificate in the card. The cryptographic coprocessor o1 the card is especially indicated for this task. Once the cards have been personalized, they are provided to the system users.

The holder of each ticket can then connect to the ticket portal they wish, normally selecting the one that interests them, and use any one of′ the methods of payment accepted by the portal in question. Once the portal decides the transaction is valid, it sends the data to be incorporated into the ticket's authentication card (a supposed value of 128 hits, more than enough for almost all applications) to the card and reader 0operators, which in this case would be the same. It also sends the purchaser's card9identifier and the identifier of the group of readers in charge of verification so that the appropriate keys can be selected. The transmission is carried out via Internet using SSL, to guarantee its integrity and authenticity.

The card operator and reader carried out the initial DES Triple encryption of the data received using the key of the indicated group of readers. Given the block size of the algorithm is 64 bits; the linked encryption of the two blocks is carried out in CBC mode (128 bits). The reader key is obtained encrypting (DES Triple) the reader identifier with a master key known only to him. Then a second DES “triple encryption is carried out (also CBC linked) using the smart card key of the ticket holder, which can be obtained, by encrypting the card identifier with a master key, as in the case of the reader. The result of these two encryptions is a block of 128 bits that makes up the ticket's authentication code. This code is returned to the portal also through SSL.

The ticket portal generates a PDF version of the ticket, which contains the authentication code in two code 128 type barcodes. The reason two barcodes are used is that, for a printing resolution of 300 dpi, the length of a WAN barcode some 75 mm for approximately 64 bits of information, which corresponds to the maximum width admitted by inexpensive barcode readers. The codes include non-coded information thus making the reading order irrelevant. The ticket also includes a numerical transcription of the code information, so that in the event this deteriorates; said information can be manually keyed in.

The PDF format of the ticket is sent to the purchaser, who can then immediately print this out using a standard printer.

When the ticket holder arrives at the entrance to the show, he hands this and the ticket to the doorman. The doorman reads the barcode and then brings the smart card over to the reader/reader without these actually coming into direct contact. At this moment the information in the barcode is transferred to the card, which checks that this is not already on the list of cancelled tickets. If this is the case, the reader: is informed, so that the doorman can proceed as appropriate. In the event the ticket is not on the list of cancelled tickets, it will he added to this, decrypted with its key grid sent to the reader. “the reader then decrypts it again using its secret key and checks that the data are consistent (date, session, seat number, etc.). If all this coincides, the admission ticket to the show will be definitively validated. Before the data are transferred between the reader and the card, firm, mutual challenge-based identification takes place and a session key that is used to encrypt the entire communication will be established.

Although it is possible to employ the system using only the encryption corresponding to the card, this is not recommendable as the card's response can be easily replaced which would considerably weaken system security.

It will be clear to anyone with an in-depth knowledge of the subject matter that this 4 method can be varied and modified in numerous different ways, and that the details given can be substituted for other technically equivalent ones, without straying From tire scope of protection defined by the attached claims.

1-27. (canceled)

28. A system for sending and validating documents using authentication codes and portable verifier elements which can process and store information and which offer a high level of protection against unauthorized readers and writers, the system comprising:
an authentication code for a particular portable verifier device;
a portable verifier device to receive the document authentication code;
at least one portable verifier device operator to encrypt the document to be decrypted by the portable verifier device;
at least one key loaded into the portable verifier device;
a document portal to select and/or purchase the document;
a reader/verifier/recorder to read the document authentication code, transmit it to the portable verifier device, receive the response, decrypts a reader operator using the corresponding code, and validates or rejects the document;
wherein the reader operator encrypts the document using the key of the group of readers/verifiers/recorders in charge of validating the document;
wherein the authentication code is indicated directly or indirectly by a person requesting the document;
wherein no data record of any type is required in the portable verifier device up to the point at which the document is validated;
wherein the portable verifier device is actively involved in the validation; and
wherein the portable verifier device contains a stored list of validated documents such that it is possible to determine, at least, whether or not this is a first validation.

29. The system according to claim 28 wherein the portable verifier device is individualized by the sender using one or more keys of the portable verifier device;
wherein the document is generated from a document portal and the data considered relevant is coded using the key that corresponds to the group of readers/verifiers/recorders involved in the validation of the document, so that the first cryptographic operation can be carried out.
wherein a second cryptographic operation is linked to the first cryptographic operation and includes the key corresponding to the portable verifier device associated with the document,
wherein an authentication code is created for the document and is incorporated therein as a result of these cryptographic operations;
wherein the document is checked by the reader and its authentication code and a third cryptographic operation is carried out to verify those already employed to generate the document;
wherein the portable verifier contains a list of validated documents such that it is possible to determine whether or not this is the first validation.

30. The system according to claim 29 wherein the individualization phase of the portable verifier devices is carried out by storing one or more portable verifier device keys, which must be an symmetric or secret key encryption algorithm;
wherein the first and second cryptographic operations are made up of two encryptions using a symmetric cryptographic algorithm, one using the key of the group of readers/verifiers/recorders involved in the validation of the document and the other using the key that corresponds to the portable verifier device associated with the document;
wherein the third cryptographic operations includes decrypting, by the portable verifier device using its corresponding key of the document's authentication code and the subsequent decryption, carried out by the aforementioned reader/verifier/recorder and its corresponding code.

31. The system according to claim 28 wherein the portable verifier devices is individualized by storing one or more portable verifier device keys, which must be the secret keys of an asymmetric or public key cryptographic algorithm;
wherein the first and second cryptographic operations are based on public key cryptography which is composed of a digital signature with a secret key, and the readers/verifiers/recorders involved in the validation of the document will know its corresponding public key, and an encryption using the corresponding public key of the portable verifier device associated with the document;
wherein the third cryptographic operations is based on a public key cryptography composed of a decryption using the secret key corresponding to the portable verifier device associated with the document and the verification of the signature, using the corresponding public key stored in the readers/verifiers/recorders.

32. The system according to claim 29 wherein the portable verifier devices is individualized by storing one or more portable verifier device keys, which must be the secret keys of an asymmetric or public key cryptographic algorithm;
wherein the first and second cryptographic operations are based on public key cryptography which is composed of air encryption using the public key of the readers/verifiers/recorders involved in the validation of the document, and an encryption using the corresponding public key of the portable verifier device associated with the document; and
wherein the third cryptographic operations is based on public key cryptography composed of a decryption using the secret key corresponding to the portable verifier device associated with the document and a decryption using the secret key of the readers/verifiers/recorders.

33. The system according to claim 29 wherein the portable verifier devices is individualized by storing one or more portable verifier device keys, which are the public keys of an asymmetric or public key cryptographic algorithm;
wherein the first and second cryptographic operation are based on public key cryptography which includes a digital signature using the secret key that corresponds to the public key stored in the readers/verifiers/recorders involved in the validation of the document and another digital signature using the secret key corresponding to the appropriate individualization key stored in the portable verifier device associated with the document; and
wherein the third cryptographic operations is based on public key cryptography composed of the verification of the signature by the portable verifier device associated with the document using the appropriate individualization key and a second verification of the signature using the public key of the readers/verifiers/recorder.

34. The system according to claim 29 wherein the portable verifier device is individualized by storing one or more portable verifier device keys, which must be the public keys of an asymmetric or public key cryptographic algorithm;
wherein the first and second cryptographic operations are based on public key cryptography which is composed of an encryption using the public key corresponding to the secret key stored in the readers/verifiers/recorders involved in the validation of the document and a digital signature using the secret key corresponding to the appropriate individualization key stored in the portable verifier device associated with the document;
wherein the third cryptographic operations will be based on public key cryptography composed of the verification of the signature by the portable verifier device associated with the document using the appropriate individualization key and a decryption using the secret key corresponding to the readers/verifiers/recorders.

35. The system according to claim 34 wherein the document is check before the document is validated.

36. The system according to claim 35 wherein the reader/verifier/recorder is informed if the document to be validated in is already included in the list of validated documents so that it can proceed as appropriate.

37. The system according to claim 36 wherein the document to be validated is included in the list of validated documents, provided it was not already there, and the corresponding cryptographic operation will he carried out when reversing, and/or checking the cryptographic operation corresponding to the portable verifier device, and the result is sent to the reader/verifier/recorder so that it can proceed as appropriate.

38. The system according to claim 29 wherein the cryptographic authentication established between the portable verifier device and the reader/verifier/recorder is mutual and firm.

39. The system according to claim 38 wherein a cooperative and random session key is established between the portable verifier device and the reader/verifier/recorder and is used to encrypt the pertinent messages between the two.

40. The system according to claim 28 wherein the portable verifier device is individualized by the senders using one or more keys obtained from the encryption of the serial number with one or more master keys chosen by the portable verifier device operators, so that the master key of each operator and the portable verifier device corresponds to the identifier, which should be legible by the user.

41. The system according to claim 28 wherein the reader/verifier/recorder has been adapted to send information, accepting or rejecting the document and stating the reason why.

42. The system according to claim. 28 wherein the reader/verifier/recorder keys are common to the group of readers.

43. The system according to claim 28 wherein the keys stored in the readers/verifiers/recorders are obtained by encrypting the identifiers, or parts of these, using the master keys chosen by the operators.

44. The system according to claim 28 wherein the document has an expiry date, this will be included in the authentication code, so that they can be eliminated from the list of validated documents stored in the portable verifier once this date has passed.

45. The system according to claim 44 wherein the portable verifier device receives the date expired document to be deleted from the list of validated documents through a digital certificate sent by a competent body.

46. The system according to claim 28 wherein the document and/or authentication code are selected and obtained through internet.

47. The system according to claim 28 wherein the document authentication code is send to the user's mobile telephone.

48. The system according to claim 28 wherein the document's authentication code is send to the user's electronic agenda or any other similar device belonging to the user.

49. The system according to claim 28 wherein the authentication code can be printed through a barcode.

50. The system according to claim 28 wherein the authentication code can be printed through one or more barcodes.

51. The system according to claim 28 wherein the authentication code can be printed through an alphanumerical code.

52. The system according to claim 28 wherein the authentication code can be printed through a dot code.

53. The system according to claim 49 wherein the authentication code can also be printed through an alphanumerical code so that it can by keyed in manually in the event the automatic reading code deteriorates.

54. The system according to claim 49 wherein the barcodes include the correct reading order.
